(19) United States
(12) Patent Application Publication
(10) Pub. No.: US 2006/0042661 A1
(43) Pub. Date: Mar. 2, 2006

(54) Oil tank sludge removal method

(76) Inventors: Douglas Scott Meyer, Baytown, TX (US); Glen Barry Brons, Phillipsburg, NJ (US); Randolph Perry, Houston, TX (US); Sam Laurens Alberick Wildemeersch, Antwerp (BE); Raymond John Kennedy, Hampton, NJ (US)

Correspondence Address: ExxonMobil Research and Engineering Company, P.O. Box 900, Annandale, NJ, 08801-0900, US

(21) Appl. No.: 11/187,671

(22) Filed: Jul. 22, 2005

Related U.S. Application Data
(60) Provisional application No. 60/605,798, filed on Aug. 31, 2004.

(51) Int. Cl. B08B 9/00

(52) U.S. Cl. 134/22.14; 134/22.1

(57) ABSTRACT

A method for removing sludge from a petroleum storage tank is based on a two-step approach utilizing solvent extraction to dissolve organic components of the sludge followed by water wash to remove inorganic materials. Sludges contain both organic-based solids (e.g., waxes and asphaltenes) as well as inorganic-based solids (known to exist as salts such as chlorides, carbonates, and oxides). The organic components of the sludge are dissolved using petroleum-based solvent streams that have been identified to possess high solvent power. The dissolved material can then be processed and recovered in the refinery using conventional refining operations. A water wash following removal of the organic materials is effective to remove the inorganic materials that can then be disposed of without the complications of the having to treat the oily organics along with them. A beneficial part of the method includes mixing and heating to improve the dissolution of soluble materials in both steps of the process.

### CROSS REFERENCE TO RELATED APPLICATION

This application claims priority under 35 USC 120 from Application Ser. No. 60/605,798, filed Aug. 31, 2004, entitled “Oil Tank Sludge Removal Method”.

### FIELD OF THE INVENTION

This invention relates to a method for removing the sludges that form in petroleum storage tanks.

### BACKGROUND OF THE INVENTION

One of the environmental problems in petroleum refining is the accumulation of sludges in the bottoms of storage tanks used for crude oils and other high gravity petroleum products. These sludges, which may accumulate to depths of one meter or more in the large tanks used for crude oils, require to be removed from the tanks from time to time both in order to maintain tankage volume as well as to prevent or decrease contamination of the products moving through the tanks. These sludges are difficult to handle efficiently: they are adherent, are solid or semi-solid and cannot be moved by conventional fluid handling equipment such as pumps. Current practices for refinery tank cleaning by physical methods, that is, by removing the sludge mechanically as a solid material, are time-consuming, labor-intensive and a high cost for refineries. As an alternative, some companies have resorted to water-washing or solvent removal techniques. Water washing has typically been accomplished by jetting water with a dispersant into the sludge to break it up and soften it, after which it can be pumped out in the form of a slurry for subsequent disposal, for example, in a cement plant. High pressure wash jets promote break-up of the mass of sludge and pressures of up to 100 bar have been used. Softening of the sludge is also assisted by the use of heated water, with temperatures of up to about 45° C. having been reported.

An alternative to water washing is solvent washing. This approach, first, will greatly reduce the costs as well as the amount of the organic materials that are otherwise disposed of at additional costs to the refinery. A number of oil companies have used solvent removal, often using crude oil as the solvent. For example, see Nippon Oil Corporation Sustainability Report 2003 (available online at http://www.eneos.co.jp/english/sustainability/index.html). The solvent cleaning process involves emptying the tank of the previous liquid oil contents (the product ordinarily stored in the tank) after which a hot hydrocarbon solvent is introduced into the tank to sufficiently cover the mixers and/or float the roof. Most of the solid hydrocarbons in the sludge will dissolve more quickly and fully with the use of mixing and heat. Mechanical breakup of the sludge can be achieved by the use of jet injectors for the chosen solvent. If no heat is available, longer mixing times or repeated solvent applications can be utilized. Following the agitation step, the hydrocarbon solvent and dissolved materials are pumped from the tank and are recovered through conventional refinery processing.

Existing techniques have, however, proved less than completely satisfactory in practice. Water wash has often failed to remove the oily sludge completely while solvent removal has been less than completely effective. Other techniques have also been proposed, for example, U.S. Pat. No. 5,580,391 describes a thermo-chemical cleaning method but this method relies upon a chemical reaction between two nitrogenous salts to generate nitrogen gas and heat to fluidize the sludge and allow collection of the oil phase which is then removed and transferred to normal refinery processing. This method, however, requires chemical supplies and observation of reaction stoichiometry for best results and is not well suited to normal operational requirements with petroleum storage tanks.

### SUMMARY OF THE INVENTION

We have now developed a tank sludge removal method which is more economical to operate, which achieves more complete removal of the sludge from the tank and which enables the removed sludge components to be handled in existing refinery units which are capable of processing such streams. It is useful for cleaning accumulated sludge from refinery crude oil tanks as well as from storage tanks used for other petroleum products producing such sludges, for example, high gravity oils of high insoluble wax and/or asphaltene contents.

The oil tank sludge removal method according to the present invention is based on a two-step approach utilizing solvent extraction to dissolve organic components of the sludge followed by water wash to remove inorganic materials. Sludges have been shown to contain both organic-based solids (e.g., waxes, and asphaltenes) as well as inorganic-based solids (known to exist as salts such as chlorides, carbonates, and oxides). The organic components of the sludge can be dissolved using petroleum-based solvent streams that have been identified to possess high solvent power. The dissolved material can then be processed and recovered in the refinery using refining operations that can process such streams. The water wash following removal of the organic materials will remove the inorganic materials that can then be disposed of without the complications of the having to treat the oily organics along with them. A beneficial part of the method includes mixing and heating to improve the degree and rate of dissolution of the organic components in the solvent streams.

### DETAILED DESCRIPTION

It has been found that petroleum oils differ in their capability to dissolve the organic components of oil tank sludges. Sludges, in addition to their inorganic content of salts, oxides and other inorganic materials, have been found to contain both waxy and non-waxy (asphaltenic) organic components and that these may be most efficaciously dissolved by appropriate selection of the solvent oil. In general terms, oils of a paraffinic character will be the most effective at removing the waxy components of the sludge while oils with a greater proportion of ring compounds (naphthenics but also aromatics) will be the most effective for dissolving the asphaltenes in the sludge. Sludges will vary in composition, of course, and no sludge will be wholly waxy or wholly asphaltenic; accordingly, it is necessary to select the solvent(s) with properties that enable dissolution of both classes of organics (waxes and asphaltenes).

Because good practices in tank operation normally dedicates tanks to the storage of a single type of crude oil, the organic portion of the sludge in crude oil tanks will usually be of a defined type, paraffinic (waxy) or asphaltenic (aromatic). For this reason, it should frequently be possible to select a solvent that is appropriate to the sludge in the tank. The sludges from crude oils used for lube production will normally be paraffinic in type since the preferred crude oils for lube runs are paraffinic, such as Arab Light, Arab Medium, Libyan, the North Sea crude oils such as Statfjord, PACRIM crude oils such as Minas. The high-asphaltenic crude oils (Maya, Venezuela, Canada and Mexico and others from the West Coast) will tend to create sludges that are richer in asphaltenes and with these sludges the high solvent power solvents with a high SBN value should be used for most effective removal of the sludge.

A suitable measure of the effectiveness of a petroleum solvent oil is its Solubility Blending Number (SBN). It has been found that oils with a high SBN, typically 80 or higher and preferably 100 or higher, will be highly effective in dissolving asphaltenic components of the sludge while, at the same time, retaining substantial effectiveness at dissolving waxy organic components. Thus, solvent oils with an SBN above 80, preferably above 100, will normally be found to be generally useful as sludge removal solvents. Oils with an SBN below 80 are, however, by no means to be excluded as they may be useful with waxy sludges.

The Solvent Blending Number, SBN, is a parameter relating to the compatibility of an oil with different proportions of a model solvent mixture such as toluene/n-heptane. The Solubility Blending Number is related to another parameter, the Insolubility Number, In, determined in a similar manner and related as set out in U.S. Pat. No. 5,871,6341. See also “The Oil Compatibility Model and Crude Oil Incompatibility”, Proceedings of the First International Conference on Petroleum Phase Behavior and Fouling, ed. by I. A. Wiehe, AIChE, New York, pp. 82-87 (1999) and I. A. Wiehe and R. J. Kennedy, “The Oil Compatibility Model and Crude Oil Incompatibility”, Energy & Fuels, 14, 56-59 (2000). The values of SBN and In referred to in this specification are those determined by the method described in U.S. Pat. No. 5,871,634.

As shown in the Examples, the values of SBN can vary over a wide range from low values typically in the range of 30-40 for light paraffinic fractions such as diesel oil to highs of over 110, reflecting an aromatic composition with significant content of two- and three-ring aromatics and cycloparaffins (naphthenes). Streams such as virgin diesel oil that are paraffinic in nature (with relatively low SBN levels) are good solvents for waxy-type sludges. Aromatic products such as coker gas oils, cycle oils that have high SBN values may be used as co-solvents to enhance the solvency power. Certain whole crude oils can also be found suitable in many instances as solvents since they normally contain a significant proportion of high boiling components which are aromatic in character and which will confer a high SBN on the oil. These more aromatic solvents will commend themselves for use as such with relatively asphaltenic sludges. Heating the solvent, for example, to temperatures of 45° or 50° C. or higher will also assist dissolution of both paraffinic and asphaltenic components in the sludge. For better economics as well as safety, the more highly refined, lighter fractions below road diesel oil, i.e., solvents which are classified as Flammable Liquids with a flash point below 40° C. (100° F.) will not normally be used as solvents for cone roof tanks. This is less of a concern for floating roof tanks where no vapor space exists.

Dissolution of the sludge is assisted by the use of hot solvent, preferably at a temperature of at least 40° C. and for best results, at least 45° C., for example, 50° C. Not only does the hot solvent dissolve the organic components of the sludge more quickly and completely but the higher temperature softens the sludge and makes it easier to break up under the mechanical mixing action which should also be applied to reduce contact time between the sludge and the solvent. Mixing action may be provided by mechanical stirrers or, more conveniently, by jet mixers. After the introduction of the solvent to the tank with suitable agitation, the solvent/sludge mixture can be left for a time, typically several days to allow the organic components of the sludge to dissolve in the solvent. Mixing may be continued by pump-around and re-circulation to the jet mixers or by continued use of tank stirrers. After the sludge has dissolved sufficiently or to the extent possible, the solution of dissolved sludge organics can be withdrawn from the tank and sent for processing in the refinery. Typically, the solvent-extracted mixture can be recovered by blending into the refinery FCC fractionation feed. The solvent is recovered in the fractionator as FCC light cycle oil with the heavier products (asphaltenes and waxes) recovered in the FCC bottoms product.

The ratio of sludge to solvent oil may vary over a wide range, typically from 1:1 to 1:10, by volume, with the exact ratio chosen being largely a matter of operational convenience and economics. Clearly, since the sludge lacks mobility, the greater the solvent/sludge ratio, the easier will be the processing of the resulting solution but, at the same time, it is undesirable to use most processed refinery streams for this purpose for economic reasons. If nothing else, the cost of distillation of the solvent will impose its own limitations. In a floating roof tank, it will normally be sufficient to add enough solvent to float the roof, before leaving the sludge and solvent to sit for a time to permit the sludge organics to dissolve in the solvent.

After the organic components of the sludge have been removed by extraction in the solvent, the inorganic residue which is left remaining will be a mass of mixed water-soluble and water-insoluble materials including salts such as carbonates, chlorides and oxides, hydrated oxides. Some of this will be corrosion products picked up by the crude oil on its way to the tanks and some will be intrinsic components of the crude oil. The water wash will be capable of removing both the water-soluble and water-insoluble inorganics; the solubles will dissolve and be pumped out in solution and the insolubles removed as slurry. The water, like the solvent, is preferably heated and similar temperatures will be appropriate. Agitation as again desirable and tank stirrers or, preferably, jet mixers can be used to blend the water in with the inorganic residue following the solvent extraction. After sufficient contact between the water and the inorganic mass has been achieved, the water and slurried inorganics can be removed from the tank outlets and sent to the waste water treatment plant.

### EXAMPLE 1

### Laboratory Testing

Samples of tank sludge taken from crude oil storage tanks which had previously been used continuously for a paraffinic/waxy crude oil were treated with various petroleum solvents of high solvent power (HSP), selected according to solvent potential. HSP streams are so identified when their SBNs are at or above 100.

Samples (10 grams) of the refinery whole crude oil tank sludges were mixed with different solvents (50 ml), with and without heating in the laboratory. After stirring overnight and allowing for settling, the relative levels of undissolved waxes remaining were measured.

| | | | Volume of |
|---|---|---|---|
| Solvent | SBN | Heating | Wax Remaining |
| HSP whole crude oil A | 116 | none | 6.0 cc |
| HSP whole crude oil A | 116 | to 65° C. (150° F.) | 0.2 cc |
| Light FCC cycle oil | 110 | to 65° C. (150° F.) | <0.1 cc |
| Virgin paraffinic diesel | 37 | none | 3.0 cc |
| Virgin paraffinic diesel | 37 | to 65° C. (150° F.) | 0.7 cc |

These data show that using such solvents are successful in dissolving the organic portion of the sludge. Also, that heating and higher SBN streams are more effective.

The virgin paraffinic diesel is more paraffinic in make up, but is a good solvent choice for more paraffinic (waxy) sludges. As shown in the field example (Example 3, below), other streams that are more paraffinic in nature (with relatively low SBN levels) are also good solvents for waxy-type sludges.

### EXAMPLE 2

### Oil Solvent Evaluation

Several refinery side-streams were evaluated for their potential as High Solvent Power feeds. These streams are listed in the table below with density and measured compatibility data.

| Feed | Density (g/cc) | SBN | In |
|---|---|---|---|
| A150 ™ | 0.89831 | 110 | 0 |
| A200 ™ | 0.99561 | 127 | 0 |
| Heavy Solvent Neutral Oil | 0.97045 | 139 | 0 |
| Light Gas Oil (Virgin Diesel) | Not measured | 37 | 0 |
| Bright Stock | 0.99027 | 98 | 0 |
| Bright Stock Extract | 0.99027 | 98 | 0 |
| | (assumed) | | |
| Light Cat Heating Oil (LCHO) | 0.95280 | 110 | 0 |
| Heavy Cat Heating Oil (HCHO) | 1.00969 | 139 | 0 |
| Heavy Cycle Gas Oil (HCGO) | 1.04219 | 139 | 0 |
| Heavy Aromatic Fuel Oil (HAFO) | 1.11133 | 189 | 102 |

LCHO: Light catalytic cracking heating oil, mostly two-ring aromatics
HCHO: Heavy catalytic cracking heating oil - two- and three-ring aromatics
HCGO: Heavy cycle gas oil - three- and four-ring aromatics
HAFO: Heavy aromatic fuel oil - catalytic cracker slurry oil

### EXAMPLE 3

### Field Testing Results

A refinery crude oil tank used for storing paraffinic type crude oils was taken out of service for maintenance. The remaining heel of crude oil was first pumped from the tank. Cleaning was necessary, prior to entry, due to the presence of approximately 1.6 m of sludge accumulated at the bottom of the tank.

Sludge Composition

The sludge appeared to contain solids and oil. The oil was presumably due to crude oil remaining in the sludge material at the bottom of the tank. To isolate the asphaltenes and other solids from the sludge, n-heptane was used to extract the sample followed by drying. The remaining solids were then analyzed for carbon and hydrogen content, thermal gravimetric analysis (TGA) and metals composition. TGA heats the sample under nitrogen from 30° C. to 800° C. at 10° C./minute to monitor weight loss of relatively volatile and non-volatile materials. At 800° C., oxygen is introduced to completely combust the sample leaving the oxides of inorganics (salts, etc.).

The TGA analysis showed that the solids contained ca. 20 wt. % ash (due to the presence of inorganic salts). The carbon and hydrogen amounted to 74.5 wt. %, which is close to the 80 wt. % non-ash materials found by TGA. The metals analysis showed that the major metals present were iron (3.9 wt. %), sodium (1.2 wt. %), calcium (0.7 wt. %), aluminum (0.2 wt. %), zinc (0.2 wt. %) and magnesium (0.1 wt. %). These data show that the inorganics present in the sludge are primarily due to salts and possibly some corrosion products for iron. The presence of salts was also observed under the microscope.

Tank Cleaning

The first step in the cleaning process involved a simple flush of the tank with the virgin paraffinic diesel of Example 1 as the solvent. This first flush was necessary to reduce the bulk volume of the sludge so tank manways, could be opened and mixers installed. Enough virgin diesel was admitted to the tank to re-float the roof. The virgin diesel solvent mixture was then pumped from the tank. With the first flush, lasting three days, the sludge level was reduced to approximately 60 cm.

Oscillating jet mixers were installed in the manways, and additional heated virgin diesel solvent (˜70° C.) introduced into the tank. Mixing was accomplished using the oscillating jet mixers for 72 hours. After the mixing was complete and the solvent mixture pumped out, the original 1.6 m feet of tank sludge had been reduced to less than 75 mm. Hydrocarbon solvent had been in the tank a total of six days. The virgin paraffinic diesel is paraffinic in composition was a good solvent choice for the relatively paraffinic (waxy) sludge in the tank. After the hydrocarbon solvent wash and mix with the oscillating jet mixers, the solvent-extracted mixture can be typically recovered in the refinery facilities as described above.

Subsequent water washing (without mixing or heating) further reduced the level of sludge to about 25 mm. After the water wash, it was possible to see the floor of the tank in many places.

Following the water wash, the oily/salty wash water was processed in the conventional refinery water treating facilities. The trace amount of oil in the water was recovered and re-processed in the refinery.

The solvent process successfully reduced the volume of sludge from about 1.6 m of difficult-to-handle material to about 25 mm of easily-removed inorganic sediment which was removed by the water wash to dissolve water-soluble components and carry out insolubles, e.g., oxides. The tank was efficiently cleaned in less than one week of solvent/water washing followed by eight days of detail clean-up vs. the traditional labor-intensive method requiring many weeks; as a result the tank returned to service much sooner. The waxes and asphaltenes were recovered as valuable product rather than requiring expensive disposal.

### EXAMPLE 4

A sample of the sludge taken from the tank referred to in Example 3 (10 g) was stirred at room temperature with 100 g of a Topacio (Equatorial Guinea) crude oil (SBN=116) and the mixture left to settle overnight, after which the top layer was decanted off and the lower 20 ml centrifuged. This yielded 12 ml oil, 1 ml water with the remainder being mainly a waxy material and a smaller amount of sediment. The organic, ash-free waxy layer had a melting point of 70° C. and contained 81.1% carbon, 12.90% hydrogen (atomic H/C ratio of 1.89), less than 0.5% nitrogen, 0.52% sulfur, 5.44% oxygen (by difference). The sediment 18% ash analyzed as:

| | |
|---|---|
| C | 34.53 |
| H | 8.89 |
| N | <0.5 |
| S | 4.16 |

Major Metals:

| | |
|---|---|
| Fe | 5.44 |
| Na | 1.01 |
| Ca | 1.09 |

### EXAMPLE 5

Example 4 was repeated but the sludge was stirred with the crude oil at a temperature of 65° C. before being allowed to settle overnight. This time, the lower layer amounted to only 5.5 ml, comprising 2 ml oil, 1.5 ml water, 0.2 ml wax with the remainder being sediment. This shows that mild heating of the solvent is far more effective in dissolving the organic components of the sludge.

### EXAMPLE 6

Example 5 was repeated but using 100 g of the light catalytic cracking heating oil (LCHO) of Example 2 (SBN=110). After overnight settling, the lower 4.8 ml was centrifuged to yield 2.5 ml oil, 1.2 ml water, less than 0.1 ml wax and sediment.

### EXAMPLE 7

Example 4 was repeated (stirred at room temperature) but using 100 g of the Light Gas Oil (LGO) of Example 2 (SBN=37). After overnight settling the lower 7.3 ml were centrifuged to yield 2.5 ml oil, 1.3 ml water, 3.0 ml wax and sediment.

### EXAMPLE 8

Example 7 was repeated but the oil and sludge were stirred at 65° C. before overnight settling. After settling, the lower 7.3 ml was centrifuged to yield 4.4 ml oil, 1.5 ml water, 0.7 ml wax and sediment.

What is claimed is:

1. A method of removing sludge from a crude oil storage tank which comprises:
contacting the sludge with an oil solvent to dissolve oil-soluble organic components of the sludge in the oil solvent
removing the oil solvent with dissolved organic components from the tank to leave a residue of inorganic sludge components and residual/insoluble organics components,
washing the residue of inorganic sludge components with water to dissolve water-soluble components of the residue and slurry the insoluble components of the residue,
removing the water with dissolved water-soluble components and slurried water-insoluble components from the tank.

2. A method according to claim 1 in which the organic components of the sludge comprise at least 50 percent by weight waxes.

3. A method according to claim 2 in which the oil solvent comprises an oil with a Solubility Blending Number of not more than 80.

4. A method according to claim 2 in which the oil solvent comprises an oil with a Solubility Blending Number of 80 to 120.

5. A method according to claim 1 in which the organic components of the sludge comprise less than 50 percent by weight waxes and more than percent by weight asphaltenes.

6. A method according to claim 5 in which the oil solvent comprises an oil with a Solubility Blending Number of 80 to 120.

7. A method according to claim 1 in which the oil solvent is at a temperature of at least 40° C. when contacted with the sludge.

8. A method according to claim 1 in which the oil solvent is agitated with the sludge.

9. A method according to claim 1 which includes the step of sending the oil solvent containing dissolved organic components of the sludge to refinery facilities for processing.

10. A method according to claim 1 which includes the steps of removing the water containing the dissolved water-soluble components of the residue together with slurried insoluble components of the residue from the tank and sending them to a waste water treatment plant.
